(19) United States
(12) Patent Application Publication
(10) Pub. No.: US 2021/0018265 A1
(43) Pub. Date: Jan. 21, 2021

(54) NOZZLE BOX FOR A DRYING DEVICE FOR DRYING BOARD-SHAPED MATERIALS

(71) Applicant: GRENZEBACH BSH GMBH, Bad Hersfeld (DE)

(72) Inventor: Christoph STRAETMANS, Bad Hersfeld (DE)

(21) Appl. No.: 16/980,475

(22) PCT Filed: Mar. 15, 2019
(86) PCT No.: PCT/EP2019/000079

§ 371 Date: Sep. 14, 2020

(30) Foreign Application Priority Data
Mar. 15, 2018 (DE) 102018002073.9

(51) Int. Cl. F26B 13/10; F26B 21/00; F26B 15/12

(52) U.S. Cl. CPC F26B 13/10; F26B 15/122; F26B 21/004

(57) ABSTRACT

A nozzle box (7, 7′) is arranged in a drying device in a transverse direction relative to a board (8) to be dried by means of drying air in the drying device. The nozzle box (7, 7′) has a tapered shape in at least one direction perpendicular to the direction of flow of the drying air in the nozzle box (7, 7′) and a drying surface provided with nozzles (18) and facing the board (8), wherein the drying air streams out of a plurality of nozzles (18) arranged in rows in the drying surface onto the board (8). The nozzle box (7, 7′) is characterized in that the ratio of the sum of the openings of the nozzles (18) per square meter to the drying surface is less than 1.1%.

The invention relates to a nozzle box, which is arranged in a drying device in a transverse direction relative to a board to be dried in the drying device by means of drying air, which has a tapered shape in at least one direction perpendicular to the direction of flow of the drying air in the nozzle box and which has a drying surface provided with nozzles and facing the board, wherein the drying air streams out of a plurality of nozzles arranged in rows in the drying surface onto the board.

A drying device serves to dry boards, which can be conveyed in decks through a drying chamber comprised by the drying device, wherein the boards in the drying device can be brought into contact with drying air produced in a ceiling unit and subsequently introduced into nozzle boxes via a pressure chamber for the purpose of drying and the drying air can be discharged via a vacuum chamber after absorbing moisture from the boards.

The drying of board-shaped materials such as gypsum boards preferably occurs by means of a predominately convective heat transfer in the form of heated air flowing over the materials. The boards, which are typically arranged over a plurality of decks, are conveyed through the dryer by means of conveying installations such as roller tracks or filter belts. In accordance with the prior art, drying plants are usually operated in a mode with recirculating air. In this mode, the drying air is guided to the boards and heated after each contact. This way, the concentration of moisture in the air continues to increase; only a small portion of the drying air is emitted to the surrounding area as exhaust air in order to discharge moisture and flue gases to the surrounding area. A differentiating feature of different dryer designs is the type of airflow over the material to be dried. The air can essentially be guided to the board in the form of a transverse ventilation, a longitudinal ventilation or a so-called impinging jet ventilation.

In transverse ventilation, the drying air is directed from the side, transversely to the direction of conveyance of the board-shaped material, over the material to be dried. Since the drying air continues to cool down during its course over the material to be dried, different drying speeds over the width ensue. This method is thus not used with sensitive materials such as gypsum boards. In longitudinal ventilation, the drying air travels over a considerable distance along the longitudinal axis of the dryer while streaming over the board and drying the latter and consequently cooling down significantly in the process. The drying air can thus be discharged at low temperatures and close to the dew point of the drying air, which is particularly advantageous from an energetic standpoint. Condensation heat can then be used in a targeted manner for the heating of fresh air by means of a heat exchanger.

In impinging jet ventilation, the drying air is directed from the side of the drying plant into nozzle boxes, also referred to as drying chambers, and blown via air-outlet nozzles perpendicularly onto the surface of the material to be dried. From there, the air streams to the opposite side of the drying plant. Dryers that work with a similar design are meanwhile used all over the world. Their advantages include the fact that, by means of their design with a plurality of relatively short drying chambers which can respectively be individually ventilated and heated, the desired drying temperature and the climate over the length of the dryer can be selected freely. The drying conditions can thus be adapted to the needs of the material to be dried. The dryer can further be adjusted superbly, for example, in the event of product changes. Due to the good heat transfer with the impinging jet flow, these dryers can be built to be considerably shorter than comparable dryers with a longitudinal ventilation in which the air streams over the material to be dried. By adjusting the inclination of the nozzle box, a very even drying can also be obtained over the width of the material to be dried. The exhaust air of each chamber is discharged and collected separately. As this also applies to chambers with high drying temperatures required by certain processes, the result is an overall high exhaust-air temperature. Even when using a heat exchanger, it is not really possible to use the condensation heat contained in the exhaust-air moisture in a meaningful manner.

Such a plant for drying gypsum boards is described in DE 19 46 696 A. A drying chamber is configured in a manner that a heat input that is as high as possible and a drying action that is as even as possible are ensured over the width of the material to be dried.

DE 26 13 512 A1 discloses a drying apparatus in which a two-stage drying method is implemented. The heat for the second drying stage is supplied from the exhaust air of the first dryer stage by a heat exchanger connected between the same. In this design, the boards are dried in the first dryer stage at a high temperature and high air humidity and in the second dryer stage at a relatively low temperature and low air humidity. The first stage is ventilated longitudinally, the second stage transversely.

DE 10 2009 059 822 B4 discloses a method for drying boards, which are conveyed in decks through a device divided into drying chambers, wherein the boards in a drying device are brought into contact with the drying air by means of an impinging jet ventilation and wherein the impinging jet ventilation is ensured by means of transversely ventilated nozzle boxes. The drying device here is a main drying stage or a final drying stage in a drying plant. A drying plant can have a plurality of drying zones operating in accordance with the impinging jet ventilation principle, as disclosed in DE 10 2005 017 187 B4.

It is the object of the present invention to improve the known nozzle box in a way so as to achieve a more intensive drying action with the same fan output and to enable the use of lower drying temperatures in order to save energy.

This object is achieved in accordance with the invention as indicated in claim 1.

If the ratio of the sum of the openings of the nozzles per square metre to the drying surface is reduced to a value of less than 1.1%, as is provided in accordance with the invention, a deterioration of the drying performance may indeed be the result.

However, if there is the same amount of air, a higher air-discharge speed results, which is associated with an intensification of the drying action. The pressure loss at the nozzles increases as a result, which facilitates the air distribution, but increases power consumption. One would thus expect a deterioration of the drying action if one were to reduce the quantity of air as a measure on its own. Surprisingly, however, it has been shown that, when the standard value according to the prior art of the ratio of the sum of the openings of the nozzles per square metre to the drying surface is reduced, a reduction of the amount of recirculating air renders possible a drying mode in which the power consumption is not higher than in a drying method according to the prior art, yet the drying action is nevertheless significantly more intensive than is the case with a standard design. A better drying action is thus achieved while the power consumption remains the same.

The pressure loss at the nozzle is higher and the flow in the overall drying area is smoother due to the reduced amount of air. Both of these conditions improve the air distribution over the number of decks and over the dryer width, whereby a greater degree of efficiency of the drying air is ultimately achieved.

An advantageous aspect of the nozzle box configured in accordance with the invention has proven to be a significant reduction of the board zones that are heated excessively in their side area. In addition, a drying device equipped with nozzle boxes structured in accordance with the invention can be started with less effort than is the case with conventional drying devices. Maintenance time is also reduced. Moreover, the air distribution is improved over the dryer chamber formed of a plurality of decks with nozzle boxes respectively arranged next to one another. A higher pressure loss is produced at the nozzles; the recirculating air in the drying air is reduced.

Overall, a more efficient drying of a board-shaped material, in particular of gypsum boards, is achieved as a consequence; a more even distribution of the drying air onto the boards to be dried is realized.

With the device in accordance with the invention, board-shaped materials can be dried gently by means of impinging jet ventilation with a reduced energy expenditure compared with the prior art.

Advantageous embodiments are indicated in the dependent claims.

An amount of recirculating air per square metre of drying surface that is less than 0.13 m³/m² contributes advantageously to an even flow of the drying air.

It is also beneficial for an even drying action when the nozzles have a diameter of less than 10 mm.

The speed of the drying air exiting the nozzles is advantageously between 17 and 21 m/s.

The air flow is also rendered more even by the selection of a spacing between the nozzles of more than 60 mm.

The nozzles are advantageously arranged in three rows extending in the longitudinal direction of the nozzle box.

The rows advantageously have a spacing of from 55 mm to 80 mm.

Alternatively, the nozzle boxes have a tapered design in the vertical spatial direction only or they additionally have a tapered structure in a further direction relative to the direction of flow of the drying air in the nozzle boxes.

In order to obtain a better orientation of the thermal radiation of the nozzle box onto the board to be dried, a deflector plate is additionally respectively arranged on the two longitudinal sides of the board laterally from the nozzle rows in the direction of the board to be dried. These consequently improve the drying action in the side area of the nozzle box, since they bundle the irradiated heat of the nozzle box in the direction of the gypsum board.

The distance of the nozzles from the board is preferably at least 22 mm and reaches a maximum value of 50 mm.

The invention relates to a drying device for drying boards, which can be conveyed in decks through a drying chamber comprised by the drying device, wherein the boards in the drying device can be brought into contact with drying air produced in a ceiling unit and subsequently introduced into nozzle boxes via a pressure chamber for the purpose of drying and the drying air can be discharged via a vacuum chamber after absorbing moisture from the boards, wherein the drying device is characterized in that it has a plurality of nozzle boxes that are designed as indicated in the foregoing.

In the following, the nozzle box in accordance with the invention is described further with the aid of an illustrative embodiment. The figures show:

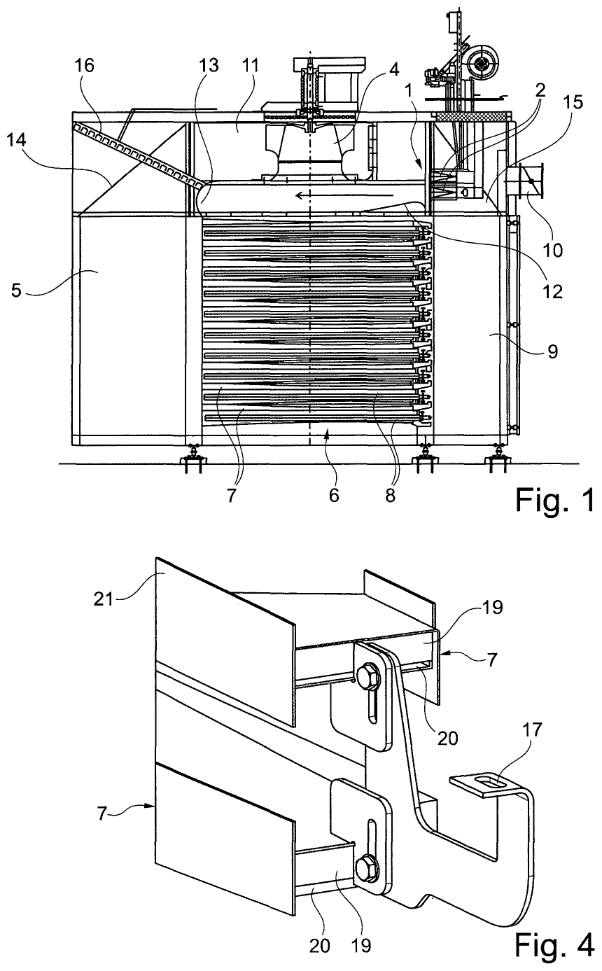

FIG. 1 a longitudinal section of a drying device with a pressure chamber, a drying chamber and a vacuum chamber,

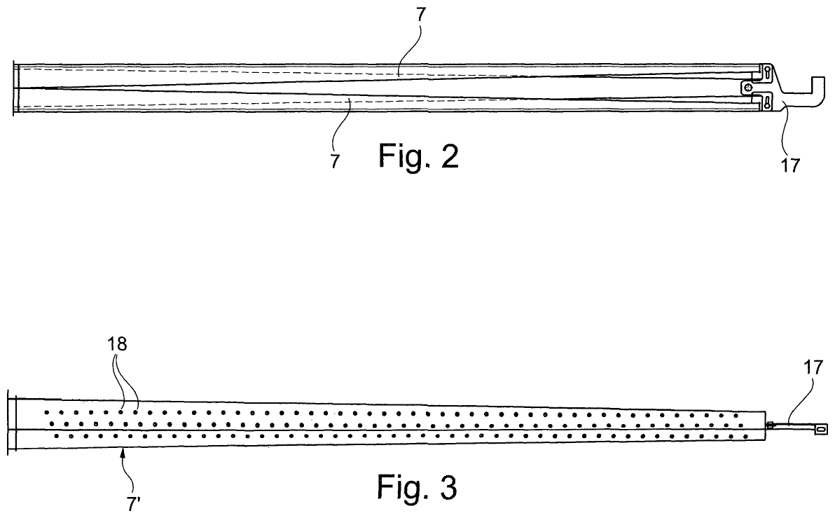

FIG. 2 a side view of two nozzle boxes according to FIG. 1, which are arranged on top of one another between respective boards to be dried,

FIG. 3 a top view of the side of a double-tapered nozzle box facing a board to be dried, and

FIG. 4 an isometric view of the end area of the nozzle box according to FIG. 2 which faces a vacuum chamber of the drying device.

Drying air, the direction of flow of which is indicated by arrows, flows in a drying device (FIG. 1) of a transversely ventilated gypsum-board cooler. Pre-heated fresh air is fed to a burner 1 as combustion air 2. The further conveyance of the air heated by the burner 1 into the pressure chamber 5 occurs via a recirculation fan 4. The pressure chamber 5 serves to distribute the air evenly into the individual decks of a drying chamber 6. In the process, the air is first pressed into nozzle boxes 7 from which it is blown perpendicularly onto gypsum boards 8 or other boards to be dried via hole nozzles arranged on the top or bottom side of the nozzle boxes. The boards 8 lie on supporting rollers and are conveyed by means of a transport installation (not described here further) in a direction perpendicular to the viewing plane of FIG. 1. The supporting rollers are arranged between and slightly above the nozzle boxes 7 so that the drying air streams between the supporting rollers onto the boards 8.

In order to ensure an optimal flow and introduction of the drying air from a ceiling unit 11 into the pressure chamber 5 and from the latter via the nozzle boxes 7 along the boards 8 into a vacuum chamber 9, the width of the pressure chamber 5 is greater than the width of the vacuum chamber 9. Guide plates 12, 13, 14 and 15 can be provided for guiding the air flow; an air-flow straightener 16 is further provided for the purpose of rendering the air flow even.

A part of the drying air, which in sum essentially corresponds to the combustion gases, the fresh air and the water vapour generated by the drying action, escapes via an exhaust-air outlet 10. The air flow circuit is completed at the burner 1.

Two nozzle boxes 7 (FIG. 2) are respectively arranged between two boards 7 to be dried. They are spaced apart from one another by an element 17 serving an attachment function on the side facing the vacuum chamber 9. FIG. 3 shows a double-tapered nozzle box 7′, which, in contrast to the nozzle boxes 7, is also tapered on the side of the vacuum chamber 9 in the plane provided with nozzles 18 from which the air flows to the board 8 to be dried.

On the side respectively facing a board 8, each nozzle box 7 is provided with nozzles 18 respectively arranged in three rows from which the drying air flows to the respective board 8.

On the side facing the vacuum chamber 9, the nozzle boxes 7 comprise a slot 20 above and below an end plate 19 (FIG. 4), through which dirt can be removed from the nozzle box 7. Deflector plates 21 are additionally arranged on each longitudinal side of the surface of the nozzle boxes 7 facing the board 8 to be dried.

1.-12. (canceled)

13. A nozzle box, wherein the nozzle box is arranged in a drying device in a transverse direction relative to a board to be dried by means of drying air in the drying device, has a tapered shape in at least one direction perpendicular to a direction of flow of the drying air in the nozzle box, and comprises a drying surface provided with nozzles and facing the board, the drying air streaming out of a plurality of nozzles arranged in rows in the drying surface onto the board, and a ratio of a sum of openings of the nozzles per square meter to the drying surface being less than 1.1%.

14. The nozzle box of claim 13, wherein an amount of recirculated air per square meter of drying surface is less than 0.13 m³/m².

15. The nozzle box of claim 13, wherein the nozzles have openings with a diameter of less than 10 mm.

16. The nozzle box of claim 13, wherein a speed of the drying air exiting the nozzles is from 17 m/s to 21 m/s.

17. The nozzle box of claim 13, wherein the nozzles are spaced apart by more than 60 mm.

18. The nozzle box of claim 13, wherein the nozzles are arranged in three rows extending in a longitudinal direction of the nozzle box.

19. The nozzle box of claim 13, wherein the rows of nozzles are spaced apart by from 55 mm to 80 mm.

20. The nozzle box of claim 18, wherein the rows of nozzles are spaced apart by from 55 mm to 80 mm.

21. The nozzle box of claim 13, wherein the nozzle box has a tapered design in a vertical spatial direction only.

22. The nozzle box of claim 13, wherein the nozzle box further comprises a deflector plate on its respective longitudinal sides laterally from the nozzle rows in a direction of the board.

23. The nozzle box of claim 13, wherein a distance of the nozzles from the board is at least 22 mm.

24. The nozzle box of claim 13, wherein the nozzle box has a double-tapered shape.

25. The nozzle box of claim 15, wherein the nozzles are spaced apart by more than 60 mm.

26. The nozzle box of claim 15, wherein the nozzles are arranged in three rows extending in a longitudinal direction of the nozzle box.

27. The nozzle box of claim 15, wherein the rows of nozzles are spaced apart by from 55 mm to 80 mm.

28. The nozzle box of claim 25, wherein the nozzles are arranged in three rows extending in a longitudinal direction of the nozzle box.

29. The nozzle box of claim 25, wherein the rows of nozzles are spaced apart by from 55 mm to 80 mm.

30. The nozzle box of claim 28, wherein the rows of nozzles are spaced apart by from 55 mm to 80 mm.

31. The nozzle box of claim 15, wherein a distance of the nozzles from the board is at least 22 mm.

32. A drying device for drying boards which can be conveyed in decks through a drying chamber comprised by the drying device, wherein the boards in the drying device can be brought into contact with drying air produced in a ceiling unit and subsequently introduced into nozzle boxes via a pressure chamber for the purpose of drying and the drying air can be discharged via a vacuum chamber after absorbing moisture from the boards, the drying device comprising a plurality of nozzle boxes according to claim 13.
